(19) United States
(12) Patent Application Publication
(10) Pub. No.: US 2005/0202206 A1
(43) Pub. Date: Sep. 15, 2005

(54) Method for manufacture of periodic cellular structure and resulting periodic cellular structure

(76) Inventors: Haydn N. G. Wadley, Keswick, VA (US); Douglas T. Queheillalt, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(21) Appl. No.: 10/515,572

(22) PCT Filed: May 29, 2003
(86) PCT No.: PCT/US03/16844

§ 371 Date: Nov. 23, 2004

Related U.S. Application Data
(60) Provisional application No. 60/384,341, filed on May 30, 2002.
(60) Provisional application No. 60/422,550, filed on Oct. 31, 2002.

(51) Int. Cl. B32B 3/12

(52) U.S. Cl. 428/116; 428/118; 428/312.6; 428/312.8

(57) ABSTRACT

A lightweight periodic cellular structure has a stacked array of hollow or solid structural elements that are bonded at their contact points in order to form a stacked lattice structure. Further arrays may be stacked onto the stacked lattice structure in order to form a periodic cellular structure of varying thickness and depth. Also, structural panels may be added to parallel exterior edges of the stacked lattice structure to form a structural panel. Further, the hollow structural elements are provided with wicking elements along their interior walls to facilitate heat transfer through the periodic cellular structure. Liquid may also be introduced into the hollow structural elements to further facilitate heat transfer through the periodic cellular structure. Also, the cellular structure may be utilized as light weight current collectors, such as electrodes, anodes, and cathodes. The related method of manufacturing the periodic cellular structure can accommodate a variety of cross-sectional shapes, introduce a variety of stacking offset angles to vary the lattice shape and resultant mechanical characteristics of the periodic cellular structure; and allow for the bending of the array of hollow or solid structural elements into an array of hollow pyramidal truss elements that can be used to form a stacked pyramidal.

### RELATED APPLICATIONS

This application claims priority from U.S. Provisional Application Ser. No. 60/384,341 filed on May 30, 2002, entitled “Method for Manufacture of Periodic Cellular Structure and Related Structure thereof,” and Application Ser. No. 60/422,550 filed on Oct. 31, 2002, entitled “Method for Manufacture of Periodic Cellular Structure and Related Structure thereof,” the entire disclosures of which are hereby incorporated by reference herein.

### U.S. GOVERNMENT RIGHTS

This invention was made with United States Government support under Grant No. N00014-00-1-0342, awarded by the Defense Advanced Research Projects Agency/Office of Naval Research. The United States Government has certain rights in the invention.

### FIELD OF THE INVENTION

The present invention relates to a lightweight periodic cellular structure fabricated using stacked arrays of wires or tubes that can be used as a multifunctional lightweight structural core for structural panels. More particularly, the present invention relates to a method of manufacturing such a lightweight periodic cellular structure using stacking and bonding techniques resulting in lightweight stacked arrays of hollow or solid structural elements and the resulting stacked arrays and pyramidal arrays resulting from this method.

### BACKGROUND OF THE INVENTION

The state of the art in the open-cell lightweight cellular structure industry is to utilize stochastic open cell metal foams as the core for such structural elements. Stochastic open cell foams lack the stiffness and strength of closed-cell (non-porous) metal foams but they possess characteristics that can be exploited in multifunctional applications. In addition to basic mechanical load support, these open cell foams possess good heat dissipation characteristics because of the ability to pump fluids through the pores in their open internal structure, they also have a high surface to volume ratio and are often used as electrodes in electrochemical cells. Such open cell foams are also being investigated for high-temperature supports for catalytic operations.

Manufacturing techniques for open cell stochastic foams include chemical or physical vapor deposition, electrolytic deposition, investment casting, and sintering processes. In most processing techniques, open cell polymer foams are used as the parent template onto which the metal foams are formed. These foams are available from a large number of manufacturers in a variety of cell sizes (typically measured as pores per inch). In addition, the various cell parameters can be modified by different techniques yielding overall foam property changes such as changes in relative density and modification of the cell size and structure within the foam.

The method of producing conductive metal porous sheet in Vaccarro, U.S. Pat. No. 5,738,907, herein incorporated by reference, accomplishes the production of open cell stochastic metal foam that can be formed into a continuously isotropic form.

The shortcomings in this technique, however, in that it does not result in a metal foam with predictable structural mechanical characteristics due to the overall lack of predictability in the metal foam's overall mechanical structure. The pores formed result in an overall isotropic structure while retaining conductivity, however, the exact shapes of pores as well as the cross-sectional shapes of the solid members surrounding the pores are unpredictable. This results therefore in an unpredictable bending modulus, tensile strength, and overall load-bearing capacity.

There are a number of methods for manufacturing periodic cellular metals as well that provide structural cores with regularly-spaced pores or channels suitable for multifunctional applications. These methods include investment casting, lattice block construction, constructed metal lattice, and metal textile lay-up techniques.

The truss panel in Hardigg, U.S. Pat. No. 4,757,665, herein incorporated by reference, discloses a structure of alternating pyramidal truss formed by a molding technique that result in a predictably-shaped and controlled structural shape.

This method however, does not provide for, among other things, precisely shaped hollow structural members that allow for directed flow of fluids to facilitate heat transfer throughout the structure of the truss panel.

There exists a need in the art for an open-cell periodic structure that has the advantages of open cell stochastic metal foams (including hollow open pores and provisions for a variety of structural shapes) with the precisely predictable mechanical properties that are currently unattainable in open cell stochastic foams. There also exists a need for a method of manufacture for such an open-cell periodic structure that allows for the maximum flexibility in construction such that a variety of geometries can be accommodated in manufacturing the periodic structure.

### SUMMARY OF THE INVENTION

According to the invention, the lightweight periodic cellular structure has a stacked array of hollow or solid structural elements that are bonded at their contact points in order to form a stacked lattice structure. Further arrays may be stacked onto the stacked lattice structure in order to form a periodic cellular structure of varying thickness and depth. Also, structural panels may be added to parallel exterior edges of the stacked lattice structure to form a structural panel.

Further, the hollow structural elements are provided with wicking elements along their interior walls to facilitate heat transfer through the periodic cellular structure. Liquid may also be introduced into the hollow structural elements to further facilitate heat transfer through the periodic cellular structure. Also, the cellular structure may be utilized as light weight current collectors, such as electrodes, anodes, and cathodes.

The method of manufacturing the periodic cellular structure can accommodate a variety of cross-sectional shapes for the hollow structural members. In addition, the method may introduce a variety of stacking offset angles to vary the lattice shape and resultant mechanical characteristics of the periodic cellular structure. Finally, the method also allows for the bending of the array of hollow or solid structural elements into an array of hollow pyramidal truss elements that can be used to form a stacked pyramidal structure to serve as an alternative core of the periodic cellular structure.

In one aspect, the present invention lightweight periodic cellular structure provides a first array of hollow and/or solid structural elements located in a first plane along a first axis; and a second array of hollow and/or sold structural elements located in a second plane along a second axis, wherein the second array is stacked immediately on top of the first array and wherein the first axis and the second axis are offset at a desired offset angle, and wherein the second array is bonded to the first array at points of contact where the first array and the second array meet to form a stacked lattice structure.

In another aspect, the present invention provides a method of constructing a lightweight periodic cellular structure comprising the steps of: arranging a first array of parallel hollow and/or solid structural elements in a first plane along a first axis; stacking a second array of parallel hollow and/or solid structural elements in a second plane along a second axis, wherein the first axis and the second axis are offset at a desired offset angle and the second plane is parallel and disposed on the first plane at a plurality of contact points; and bonding the second array to the first array at the plurality of contact points to form a stacked lattice structure.

In another aspect, the present invention arranging a first array of hollow and/or solid parallel structural elements in a first plane along a first axis; stacking a second array of hollow and/or parallel structural elements in a second plane along a second axis, wherein said first axis and said second axis are offset at a desired offset angle and said second plane is parallel and disposed on the first plane at a plurality of contact points; bonding the second array to said first array at said plurality of contact points to form a stacked lattice structure; and bending said stacked lattice structure to a desired bending angle at a select number of said contact points to form a pyramidal cellular core.

The invention itself, together with further objects and attendant advantages, will best be understood by reference to the following detailed description taken in conjunction with the accompanying drawings.

### BRIEF DESCRIPTION OF THE DRAWINGS

The foregoing and other objects, features and advantages of the present invention, as well as the invention itself, will be more fully understood from the following description of preferred embodiments, when read together with the accompanying drawings, in which:

FIG. 1 is a photographic depiction of a perspective view of a stacked lattice core structure of the present invention where the hollow tube arrays are stacked in alternating perpendicular arrays and bonded to form a stacked lattice core.

FIG. 2 is an photographic depiction of a plan view of a two-layer stacked lattice structure of the present invention where the two hollow tube or solid ligament arrays are stacked and bonded such that the second wire array is offset at an angle less than 90 degrees from the first hollow tube or solid ligament array.

FIG. 3 is a schematic illustration of a perspective view of the stacked lattice periodic cellular structure of the present invention where the hollow tube or solid ligament arrays are stacked in alternating perpendicular arrays and bonded to form a stacked lattice core and structural panels have been bonded to the orthogonal edges of the periodic cellular core to form a structural panel.

FIG. 4 is a schematic illustration of a perspective view of the stacked lattice periodic cellular structure of the present invention where the hollow tube or solid ligament arrays are stacked in alternating perpendicular arrays and bonded to form a stacked lattice core and structural panels have been bonded to the exterior of the stacked lattice core at an angle of 45 degrees from the orthogonal edges of the periodic cellular core to form a structural panel.

FIG. 5 is a schematic illustration of a perspective view of the stacked pyramidal periodic cellular structure of the present invention where the hollow or solid pyramidal truss elements are bonded to form a pyramidal core and structural panels have been bonded to the exterior of the pyramidal core to form a structural panel.

FIG. 6 is a photographic depiction of a side view of the stacked pyramidal periodic cellular structure of the present invention showing the desired bending angle of the pyramidal periodic cellular core.

FIG. 7 is a perspective view of the stacked pyramidal periodic cellular structure shown in FIG. 6.

FIG. 8 is a schematic illustration of one embodiment of the bending technique used to form the stacked pyramidal periodic cellular structure of the present invention.

### DETAILED DESCRIPTION OF THE INVENTION

Turning now to the drawings, the subject invention, as shown In FIGS. 1, 2, 3, and 4 includes a first array of hollow or solid structural elements 1 oriented along a first axis 5 and in a first plane 3. Upon the first array of hollow structural elements 1 are stacked a second array of hollow or solid structural elements 2 oriented along a second axis 6 and in a second plane 4. As shown in FIGS. 1, 2, 3, and 4 the stacked arrays of hollow structural elements 1,2 are then bonded together at their respective contact points 7. Bonding techniques for attaching the arrays of hollow or solid structural elements 1, 2 may include: brazing or other transient liquid phases, adhesives, diffusion bonding, resistance welding, electron welding, or laser welding. FIG. 2 shows the first two arrays of hollow or solid structural elements 1, 2 from a top view as well as the contact points 7 where the bonding occurs. FIG. 2 also depicts the offset angle 15 between the first array of hollow or solid structural elements 1 and the second array of hollow or solid structural elements 2. This angle can be varied from 0 to 90 degrees to alter the mechanical properties of the resulting stacked lattice structure 10 shown in FIG. 1, for example.

The resulting stacked lattice structure 10 as shown in FIG. 1 is used as a core for the periodic cellular structure of the present invention. Optionally, located along the inner diameter of the arrays of hollow structural elements 1, 2 are wicking elements (not shown) which act to facilitate heat transfer throughout the stacked lattice structure 10.

In addition, according to the design criteria discussed throughout, other hollow structural designs of the present invention are provided. As shown in co-pending and co-assigned PCT International Application No. PCT/US01/22266, entitled “Heat Exchange Foam,” filed on Jul. 16, 2001, and corresponding U.S. application Ser. No. 10/333,004, filed Jan. 14, 2003, of which are hereby incorporated by reference herein in their entirety, there is provided other ways of forming the structural elements that includes a core that is comprised of an open cell having solid or hollow ligaments, foam, and/or interconnected network. The resultant hollow ligaments that have a substantially circular (rounded) cross section will require an internal wicking structure to effect a heat pipe. Otherwise, an interconnected cellular or truss network that has hollow ligaments having a triangular or cusp-like shaped cross section, or an acute-angled corner will not require an internal wicking mechanism to effect a heat pipe. The corner regions of the heat pipe act as return channels or groves.

According to the design criteria discussed throughout, other two-dimensional and three-dimensional structures may be implemented with the present invention as shown in co-pending and co-assigned PCT International Application No. PCT/US02/17942, entitled “Multifunctional Periodic Cellular Solids and the Method of Making thereof,” filed on Jun. 6, 2002, of which is hereby incorporated by reference herein in its entirety.

According to the design criteria discussed throughout, other two-dimensional and three-dimensional structures may be implemented with the present invention as provided in co-pending and co-assigned PCT International Application No. PCT/US01/17363, entitled “Multifunctional Periodic Cellular Solids and the Method of Making thereof,” filed on May 29, 2001, and corresponding U.S. application Ser. No. 10/296,728, filed Nov. 25, 2002, of which are hereby incorporated by reference herein in their entirety.

In addition, because of the tubes being hollow, additional functionality can be readily integrated into the structures described in this document. For example, the hollow nature of the tubes allow for the structure to become a very lightweight current collector for the integration of power storage devices such as batteries. For example, according to the design criteria discussed throughout, as shown in co-assigned PCT International Application No. PCT/US01/25158, entitled “Multifunctional Battery and Method of Making the Same,” filed on Aug. 10, 2001, and corresponding U.S. application Ser. No. 10/110,368, filed Jul. 22, 2002, of which are hereby incorporated by reference herein in their entirety, there is provided other ways of forming current collectors.

There are numerous other functionalities, which can be added into these structures making them ideal candidates for “structure plus” multifunctional materials.

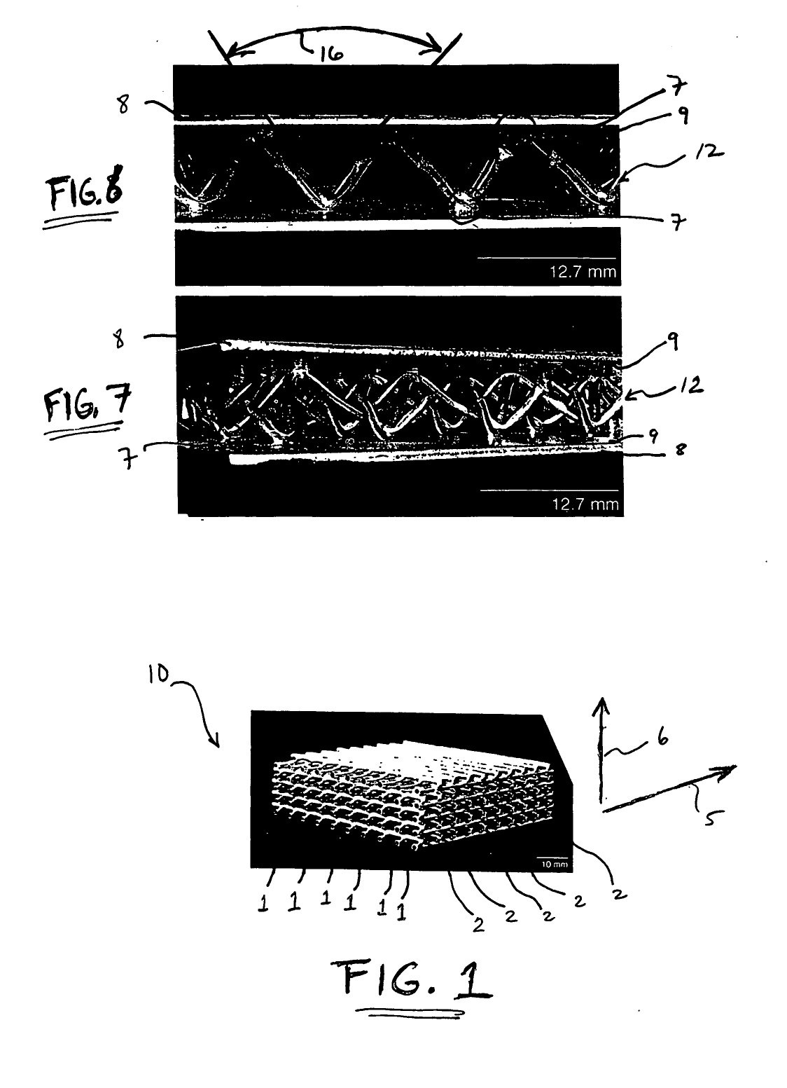

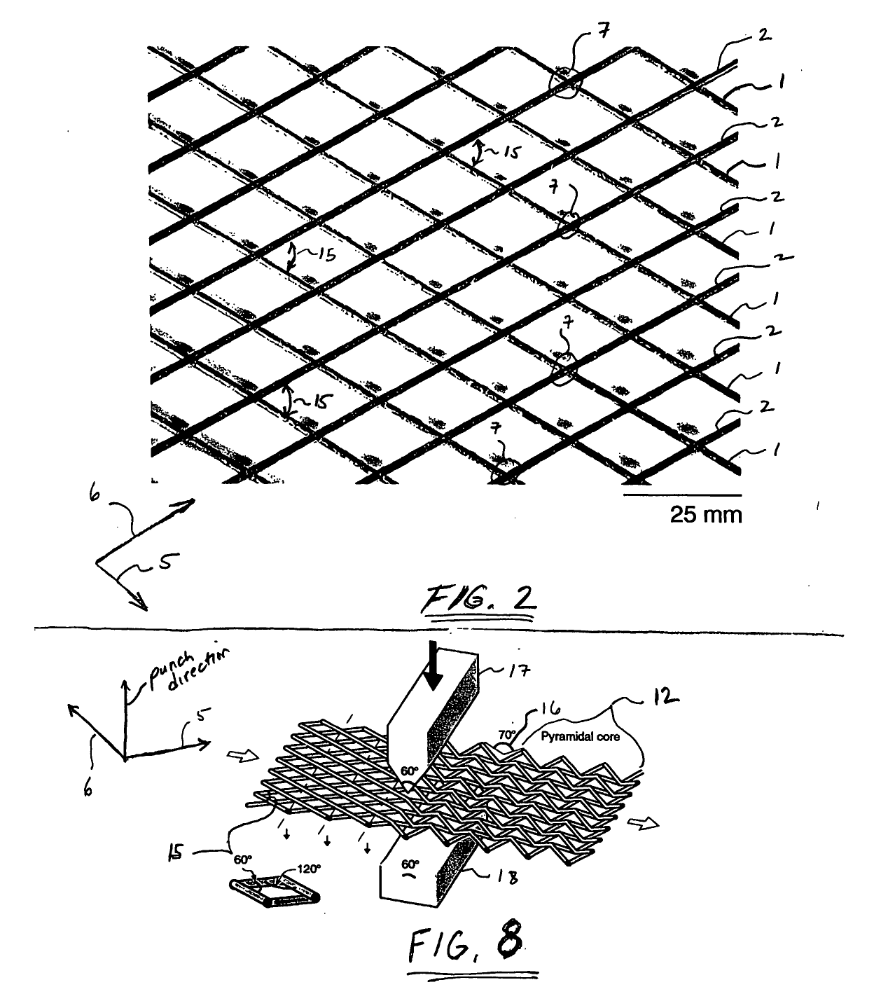

As shown in FIGS. 3 and 4, the stacked lattice structure is sandwiched between two parallel structural panels 8 which can be constructed of metal or some non-conductive structural material including polymers or structural composites. The structural panels are affixed to any two parallel exterior surfaces 9 of the stacked lattice structure 10 using any of the bonding techniques listed above for bonding the arrays of hollow structural elements 1,2. The resulting periodic cellular structure is one embodiment of the subject invention.

As shown in FIGS. 1, 2, 3, and 4 the arrays of hollow structural elements 1, 2 may be circular in cross section. The cross sectional shapes of the hollow structural elements may also be varied in order to change the overall structural properties of the stacked lattice structure 10. Possible cross sectional shapes for the hollow structural elements include: circular, triangular, rectangular, square, and hexagonal.

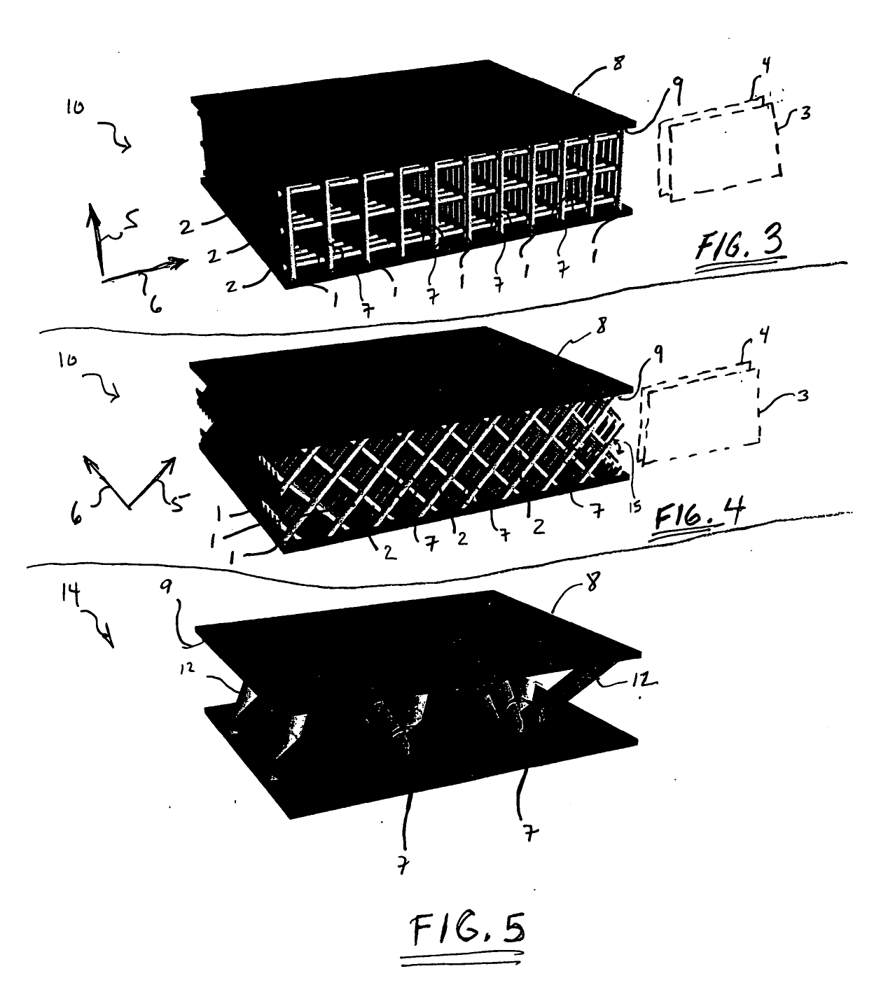

We turn now to an alternate embodiment of the subject invention as shown in FIGS. 5 and 6. In this embodiment as depicted in FIG. 5, a first array of hollow or solid pyramidal truss elements 12 is oriented along a desired plane or contour. Upon the first array of hollow or solid pyramidal truss elements 1 it is possible to stack additional arrays of hollow or solid pyramidal truss elements oriented as desired (not shown). The array of pyramidal truss elements 12 are bonded together at their contact points 7 to serve as the structural core for this embodiment of the subject invention. As in the first embodiment, bonding techniques for attaching the first array of hollow or solid pyramidal truss elements 12 to a second array or third array and structural panel 8 may include: brazing or other transient liquid phases, adhesives, diffusion bonding, resistance welding, electron welding, or laser welding. Also, as in the first embodiment, the offset angle of the legs or ligaments can be varied from 0 to 90 degrees to alter the mechanical properties of the resultant pyramidal structure 12.

The resulting pyramidal structure 12 as shown in FIGS. 5 and 6 is used as a core for the periodic cellular structure that is an alternate embodiment of the subject invention. As in the first embodiment, located along the inner diameter of the arrays of hollow or solid pyramidal truss elements 12 are wicking elements (not shown) which act to facilitate heat transfer throughout the pyramidal structure 12.

As shown in FIGS. 5, 6, and 7, and in a manner similar to the first embodiment, the stacked pyramidal structure is sandwiched between two parallel structural panels 8 which can be constructed of metal or some non-conductive structural material including polymers or structural composites. The structural panels are affixed to any two parallel exterior surfaces 9 of the pyramidal structure 12 using any of the bonding techniques listed above for bonding the arrays of hollow pyramidal truss elements 12.

It should be appreciated that the parallel structural panels 8 as discussed throughout can be planar, substantially planar, and/or curved shape, with various contours as desired.

FIG. 6 shows a side view of the alternate embodiment of the subject invention where the core of the periodic cellular structure comprising a stacked pyramidal structure 12 bonded to two structural panels 8 along parallel exterior surfaces 9 of the stacked pyramidal structure 12. FIG. 6 also depicts the desired bending angle 16 of the arrays of hollow pyramidal truss elements 12. This desired bending angle 16 can be varied between 0 and 180 degrees to adjust the overall mechanical properties of the stacked pyramidal structure 12.

Similarly, FIG. 7 shows a perspective view of the embodiment the stochastic cellular structure shown in FIG. 6, which comprises a pyramidal structure 12 bonded to two structural panels 8 along parallel exterior surfaces 9 of the pyramidal structure 12.

FIG. 7 shows the intertwined solid or hollow ligaments of the stochastic hollow or solid pyramidal truss elements 12.

As shown in FIG. 5 the arrays of hollow or solid pyramidal truss elements 12 may be circular in cross section. The cross sectional shapes of the hollow or solid pyramidal truss elements 12 may also be varied as in the first embodiment in order to change the overall structural properties of the pyramidal structure 12. Possible cross sectional shapes for the hollow pyramidal truss elements 12 include: circular, triangular, rectangular, square, and hexagonal.

Finally, we turn to the methods for producing the above embodiments of the subject invention. The method for producing the stacked lattice structure 10 as shown in FIGS. 1, 3, and 4 is as described in the above detailed description of the first embodiment. The first and second arrays of hollow structural elements 1,2 are stacked and bonded at their contact points 7 such that the arrays are aligned at a desired offset angle 15. Bonding techniques may include, but are not limited to, the techniques listed above in the detailed description of the first embodiment of the subject invention. The stacking and bonding steps can be repeated to add and bond further arrays of hollow structural elements until a stacked lattice structure 10 of the desired size is obtained. As a final step, structural panels 8 can be added to sandwich the stacked lattice structure 10 along parallel exterior surfaces 9 to form a structural panel.

The method for producing the alternate embodiment stacked pyramidal structure 12 as shown in FIGS. 5 and 6 begins with the stacking of two arrays of hollow structural elements as shown in FIG. 2. First, a first array of hollow structural elements 1 is prepared. Upon this first array 1, is stacked and bonded (using any of the bonding techniques described above) a second array of hollow structural elements 2 to form a two-layer stacked lattice structure as shown in overhead view in FIG. 2. The two-layer stacked lattice structure is them subjected to a bending operation such that the two layer stacked lattice structure is bent to a desired bending angle 16 as shown in FIG. 6 to form the resulting stacked pyramidal structure 12.

FIG. 8 depicts one method of completing the bending step in order to achieve a desired bending angle 16 of the pyramidal structure 12. A wedge-shaped punch 17 is applied in a direction perpendicular to the planes of the first and second arrays of hollow structural elements 1,2 as shown in FIG. 2. As shown in FIG. 8, the wedge-shaped punch 17 used to bend the two-layer stacked lattice structure into an interlocking die 18 such that the desired bending angle 16 is achieved in the resulting pyramidal structure 12. Alternatively, a press, stamp, or rolling process (e.g., passage through a set of saw-toothed rollers) may be used. An exemplary illustration of an end result is represented by FIGS. 6-7.

The embodiments and methods of manufacture for the embodiments described above provide a number of significant advantages. First of all, the methods of producing these periodic cellular structures allows for infinite variation in the cross-sectional size and shape of the arrays of hollow and solid structural elements 1,2 and the arrays of hollow and solid pyramidal truss elements 12 that make up the resulting stacked lattice structures 10 and stacked pyramidal structures. This flexibility is accomplished while still allowing for hollow passageways within the arrays of hollow structural elements 1, 2 whereby wicking elements 11 and fluids may be introduced in order to obtain optimum heat transfer performance within the periodic cellular structure. While the prior art open cell stochastic metal foams allow for improved heat transfer in their open pores, the unpredictable nature of the size and shape of the resultant pores makes them unpredictable and unreliable as load bearing structures. The present invention provides for the best heat transfer properties of open cell stochastic metal foams with the geometric and structural certainty of an engineered truss structure.

In addition, the subject invention provides for easy construction using a variety of bonding techniques. Where open cell stochastic metal foams require some stretching and temperature processing to achieve the slightest isotropic tendencies, the present invention provides for exacting control over all of the mechanical properties of the resulting periodic cellular structure by adjustment of: the cross sectional shapes of the arrays of hollow structural elements 1,2, the desired offset angle 15 between the first and second arrays 1,2 and the desired bending angle 16 in the case of the pyramidal structure 12 described above as the alternate embodiment. In addition, the structural rigidity and surface area of the wicking elements contained within the periodic cellular structure by increasing the density of parallel hollow structural elements within the stacked arrays 1,2 and pyramidal truss elements 12.

Overall, the subject invention provides a way to combine the best heat transfer capabilities of the open cell stochastic metal foam with the structural integrity and predictability of engineered truss shapes in a method that is simple and inexpensive to perform.

Of course it should be understood that a wide range of changes and modifications could be made to the preferred and alternate embodiments described above. It is therefore intended that the foregoing detailed description be understood that it is the following claims, including all equivalents, which are intended to define the scope of this invention.

1. A lightweight periodic cellular structure, said cellular structure comprising:
a first array of structural elements located in a first plane along a first axis; and
a second array of structural elements located in a second plane along a second axis, wherein said second array is stacked immediately on top of said first array and wherein said first axis and said second axis are offset at a desired offset angle, and wherein said second array is bonded to said first array at points of contact where said first array and said second array meet to form a stacked lattice structure.

2. The cellular structure of claim 1, comprising a pair of parallel structural panels bonded to selected parallel exterior surfaces of said stacked lattice structure.

3. The cellular structure of claim 1, wherein said desired offset angle is between about 0 and about 90 degrees.

4. The cellular structure of claim 1 wherein said structural elements have a circular cross-section.

5. The cellular structure of claim 1 wherein said structural elements have a triangular cross-section.

6. The cellular structure of claim 1, wherein said structural elements have a rectangular cross-section.

7. The cellular structure of claim 1, wherein said structural elements have a hexagonal cross-section.

8. The cellular structure of claim 1, wherein said first array and said second array are an array of pyramidal truss elements.

9. The cellular structure of claim 8, wherein a plurality of said pyramidal truss elements are hollow.

10. The cellular structure of claim 9, comprising a plurality of wicking elements located inside said hollow pyramidal truss elements to facilitate heat exchange within said cellular structure.

11. The cellular structure of claim 8, comprising a pair of parallel structural panels bonded to selected parallel exterior surfaces of said stacked pyramidal structure.

12. The cellular structure of claim 1 wherein a plurality of said structural elements are hollow.

13. The cellular structure of claim 12, comprising a plurality of wicking elements located inside said hollow structural elements to facilitate heat exchange within said cellular structure.

14. The cellular structure of claim 8 wherein said pyramidal truss elements have a circular cross-section.

15. The cellular structure of claim 8 wherein said pyramidal truss elements have a triangular cross-section.

16. The cellular structure of claim 8, wherein said pyramidal truss elements have a rectangular cross-section.

17. The cellular structure of claim 8, wherein said pyramidal truss elements have a hexagonal cross-section.

18. A method of constructing a lightweight periodic cellular structure comprising the steps of:
arranging a first array of parallel structural elements in a first plane along a first axis;
stacking a second array of parallel structural elements in a second plane along a second axis, wherein said first axis and said second axis are offset at a desired offset angle and said second plane is parallel and disposed on said first plane at a plurality of contact points; and
bonding said second array to said first array at said plurality of contact points to form a stacked lattice structure.

19. The method of claim 18, further comprising sandwiching said stacked lattice structure between two parallel structural panels.

20. The method of claim 18, further comprising repeating said arranging, stacking, and bonding steps to construct multiple layers of said lattice to form a repeating cellular core.

21. The method of claim 20, further comprising sandwiching said repeating cellular core between two parallel structural panels.

22. The method of claim 18 wherein said stacking step further comprises stacking said second array such that said desired offset angle is between about 0 and about 90 degrees.

23. The method of claim 18 wherein said bonding step comprises transient liquid phase sintering said first array to said second array.

24. The method of claim 18 wherein said bonding step comprises brazing said first array to said second array.

25. The method of claim 18 wherein said bonding step comprises diffusion bonding said first array to said second array.

26. The method of claim 18 wherein said bonding step comprises resistance welding said first array to said second array.

27. The method of claim 18 wherein said bonding step comprises electron welding said first array to said second array.

28. The method of claim 18 wherein said bonding step comprises laser welding said first array to said second array.

29. A method of constructing a lightweight periodic cellular structure comprising the steps of:
arranging a first array of parallel structural elements in a first plane along a first axis;
stacking a second array of parallel structural elements in a second plane along a second axis, wherein said first axis and said second axis are offset at a desired offset angle and said second plane is parallel and disposed on said first plane at a plurality of contact points;
bonding said second array to said first array at said plurality of contact points to form a stacked lattice structure; and
bending said stacked lattice structure to a desired bending angle at a select number of said contact points to form a pyramidal cellular core.

30. The method of claim 29, further comprising sandwiching said pyramidal cellular core between two parallel structural panels.

31. The method of claim 29, further comprising repeating said arranging, stacking, and bonding steps to construct multiple layers of said lattice to form a repeating cellular core.

32. The method of claim 31, further comprising sandwiching said repeating cellular core between two parallel structural panels.

33. The method of claim 29 wherein said stacking step further comprises stacking said second array such that said desired offset angle is between about 0 and about 90 degrees.

34. The method of claim 29 wherein said bonding step comprises transient liquid phase sintering said first array to said second array.

35. The method of claim 29 wherein said bonding step comprises brazing said first array to said second array.

36. The method of claim 29 wherein said bonding step comprises diffusion bonding said first array to said second array.

37. The method of claim 29 wherein said bonding step comprises resistance welding said first array to said second array.

38. The method of claim 29 wherein said bonding step comprises electron welding said first array to said second array.

39. The method of claim 29 wherein said bonding step comprises laser welding said first array to said second array.

40. The method of claim 29 wherein said bending step comprises applying a wedge-shaped punch and interlocking die in a direction perpendicular to said first and second planes.

41. The method of claim 29 wherein said bending step comprises applying a press, stamp, punch, or wedge to said stacked lattice structure to achieve the desired bending angle.
